(19) United States
(12) Patent Application Publication
(10) Pub. No.: US 2005/0160252 A1
(43) Pub. Date: Jul. 21, 2005

(54) SYSTEM FOR PROCESSING DATA STREAMS IN MPEG FORMAT AND METHOD FOR PROCESSING DATA STREAMS IN MPEG FORMAT

(75) Inventors: Marcin NOWAKOWSKI, Czerwiensk (PL); Wojciech BYRTEK, Sosnowiec (PL)

Correspondence Address: SCHOLL PATENT AGENCY, INC.;DR. MATTHIAS SCHOLL, 14781 MEMORIAL DRIVE, SUITE 1319, HOUSTON, TX, 77079, US

(73) Assignees: ADVANCED DIGITAL BROADCAST POLSKA SPOLKA Z O.O., Zielona Gora (PL); ADVANCED DIGITAL BROADCAST LTD., Hsin-Tien City (TW)

(21) Appl. No.: 10/905,698

(22) Filed: Jan. 18, 2005

(30) Foreign Application Priority Data
Jan. 21, 2004 (PL) P-364506

(51) Int. Cl. G06F 15/00

(52) U.S. Cl. 712/20

(57) ABSTRACT

A system for processing data streams in MPEG format has a system controller (110) and an MPEG decoder (115), a memory (121) for storing data streams, a demodulator (151), a signal controller (140), which contains a signal processing system (142) and a digital part (141) of a modulator and an analog part (131) of which constitutes a separate system block. The signal processing system (142) of the signal controller (140) is connected with the demodulator (151), the digital part (141) of the modulator connected with its analog part (131) and the processor (113) of the system controller. The signal processing system (142) of the signal controller (140) receives digital data stream from the demodulator (151) and from the processor (113) and after processing them, it sends the output stream to the digital part (141) of the modulator and to the processor (113).

### CROSS-REFERENCE TO RELATED APPLICATIONS

This application claims priority to Polish Application No. P-364506, filed Jan. 21, 2004, the contents of which are incorporated herein by reference.

### BACKGROUND OF THE INVENTION

1. Field of the Invention

The subject of the invention is a system for processing data streams in MPEG format and a method for processing data streams in MPEG format.

Brief Description of the Background of the Invention Including Prior Art

There are different systems known for processing and modulation of television data streams. Such systems can be used for generating test signals for digital television decoders.

One example of such system is a system based on a PC-type computer architecture, with specialized extension cards (for example, with modulator and demodulator circuits) and dedicated software. However, the price of such system is relatively high.

Another example of a device for signal processing and modulation is a transmodulator. One type of a transmodulator has been described in the PCT application No. WO 03/084217 “DVB-T to DVB-S Converter”. It presents a converter apparatus for converting Terrestrial Digital Video Broadcasting format (DVB-T) to Satellite Digital Video Broadcasting format (DVB-S). Its main function is signal conversion, without additional specialized signal processing. Therefore, its functionality is limited and it cannot be used as a generator of a test stream for a digital television decoder.

There are also known stand-alone modulator devices. Their drawback is that they are not equipped with a demodulator and they are suited for handling a limited number of modulation systems. Some of the modulators are equipped with a stream storage system, for example a hard disk or a CD-ROM, but the price of such devices is relatively high due to a specialized architecture.

### SUMMARY OF THE INVENTION

Purposes of the Invention

It is an object of this invention to provide a simple and inexpensive device for generating digital television data streams, especially streams for testing components of digital television decoders.

It is another object of this invention to provide a method allowing an easy testing of decoders.

These and other objects and advantages of the present invention will become apparent from the detailed description, which follows.

Brief Description of the Invention

A system for processing data streams in MPEG format has a system controller containing a processor with an ATA interface, an MPEG decoder and other I/O blocks as well as a memory for storing data streams linked to the system controller, a demodulator linked to the system controller, a signal controller linked to the system controller and containing a signal processing system and a digital part of modulator and an analog part of modulator connected with the digital part of modulator of the signal controller and the processor of the system controller. The signal processing system of the signal controller receives a first digital data stream from the demodulator and a second digital data stream from the processor and after processing them, it sends an output stream to the digital part of modulator and to the processor.

The software of the processor of the system controller can contain a signal controller operating program for controlling operation of the signal controller.

The memory for storing data streams can be a hard disk drive.

The system for processing streams can have an additional data interface connected to the signal processing system, an additional data interface connected to the system controller and an additional data source connected to the processor.

The additional data interface connected to the signal processing system can be an SPI port.

The additional data interface connected to the system controller can be an Ethernet interface.

The additional data source connected to the processor can be an MPEG encoder.

The signal processing system can receive data from the processor in a Memory Interface format and process data internally in a Transport Stream format. The signal processing system can contains an input interface and an output interface for exchanging data with the processor which convert data from the Transport Stream format to the Memory Interface format and vice versa.

The input interface and the output interface for exchanging data with the processor can contain buffers for preventing irregular data transfer.

The signal processing system can contain PID filters, a PCR modifier, a packet mixer, a PID generator and/or a block for inserting stuffing packets.

A method for processing data streams in MPEG format in a system for processing data streams, containing a system controller with a processor and an MPEG decoder, a memory for storing data streams, a demodulator, a signal controller linked to the system controller and containing a signal processing system and a digital part of modulator and an analog part of modulator, the method comprises steps of receiving at least two streams by the signal controller and processing the received streams by the signal processing system, outputting a single output stream and modulating it by the analog and digital parts of modulator to a specific modulation system.

The streams can be received from the demodulator and/or the hard disk drive and/or an external source.

The processing of the received streams can involve packet filtering and streams mixing.

The output unmodulated stream can be sent to the MPEG decoder.

The output stream after modulation can be used as a test stream for digital television decoders.

A method for processing data streams in MPEG format in a system for processing data streams, containing a system controller with a processor and an MPEG decoder, a memory for storing data streams, a demodulator, a signal controller linked to the system controller and containing a signal processing system and a digital part of modulator and an analog part of modulator, the method can also comprise steps of receiving by the signal controller a data stream from the demodulator and from the processor, processing the received data streams by the signal processing system into an output stream and sending the output stream to the digital part of modulator and to the processor.

### BRIEF DESCRIPTION OF THE DRAWINGS

In the accompanying drawings one of the possible embodiments of the present invention is shown, where:

FIG. 1 shows a schematic diagram of a basic embodiment of a data processing system;

FIG. 2 shows a schematic diagram of a basic embodiment of a signal controller;

FIG. 3 presents a schematic diagram of an extended embodiment of a data processing system; and

FIG. 4 presents a schematic diagram of an extended embodiment of a signal controller.

### DESCRIPTION OF INVENTION AND PREFERRED EMBODIMENT

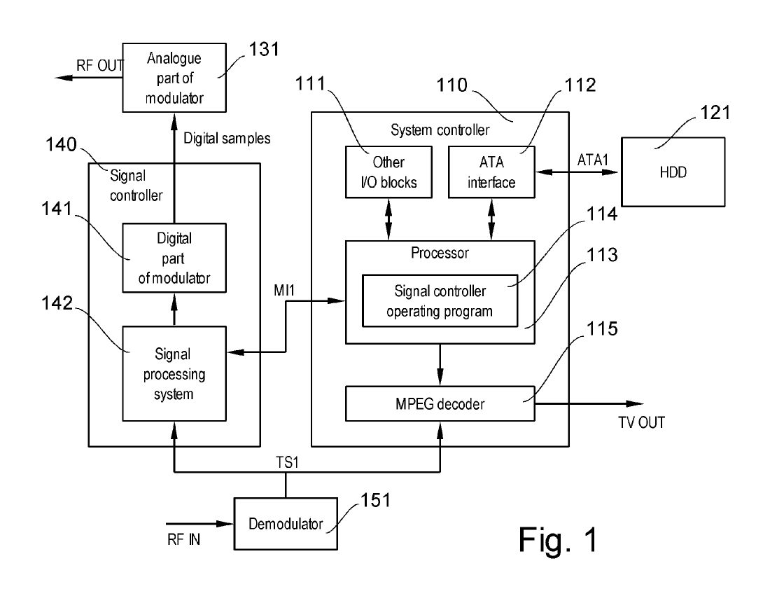

FIG. 1 illustrates the structure of the basic embodiment of a data processing system. It comprises a signal controller 140, which receives data, at least from the system controller 110 and the demodulator 151, which receives a modulated RF IN stream. The signal processing system 142, embedded in the signal controller 140, facilitates the processing of the received data, and sending them to the processor 113 and the modulator. The digital part 141 of the modulator is embedded in the signal controller 110, to which the analog part of the modulator 131 is connected as an external circuit. Such solution allows application of different modulation systems in the system, by changing the software of the digital part 141 of the modulator. The processed and modulated data can be transmitted to the digital television decoder. The data processing system controller 110 comprises a processor 113 and additional circuits, commonly used in digital television decoders. The processor 113 operates different programs, including a program 114 for operating the signal controller. Besides, the system controller 110 can contain a decoder of the MPEG format 115, which processes data from the MPEG format into a format that is acceptable by the television receiver (TV OUT). In another embodiment, the MPEG decoder can be an external circuit. The system controller 110 also includes an ATA interface 112 or a similar one, which facilitates data exchange with the hard disk drive 121. The processor 113 can also cooperate with other input/output blocks 111, for exchange of data with other devices.

The signal controller operating program 114 performs, for example, the setting of values of appropriate registers, which control the operation of separate signal controller blocks. Moreover, this program can upgrade some of the signal controller software, for example, the software of the digital part of the modulator, in order to change the modulation method.

The signal processing system 142 enables processing of the received data streams (for example—packet filtering, data modification in packets, joining streams, etc.) and generates output streams.

In the simplest embodiment, the signal processing system 142 receives data from the demodulator 151 and the processor 113 and sends data to the processor 113 and to the digital part of the modulator 141. The digital part of the modulator 141 allows generating digital samples for the analog part of the modulator 131, which generates the analog RF OUT stream in a specific frequency band. The placement of the digital part of the modulator 141 inside signal controller 140 allows designing a universal system, in which different types of modulation can be applied, without interfering with the physical structure of the system. The modulation type can be changed by modifying the software of the digital part of the modulator 141.

Data streams are transmitted in the presented system in two formats, namely in TS (Transport Stream) format, which is a standard format of the transport layer of MPEG data (for example MPEG-2 data) and MI (Memory Interface) format, which is a format of data exchange with the system controller processor. The TS format is standardized, while the MI format may differ according to the type of the processor.

In the basic embodiment, the data streams transmitted within the system are TS1, ATA1 and MI1 streams. TS1 is a digital television data stream received by the demodulator 151 and transmitted unidirectionally to the signal processing system 142 and to the MPEG decoder 115. ATA1 is a data stream transmitted bidirectionally between the hard disk drive 121 and the processor 113 via the ATA interface 112. MI1 is a data stream transmitted bidirectionally between the signal processing system 142 and the processor 113.

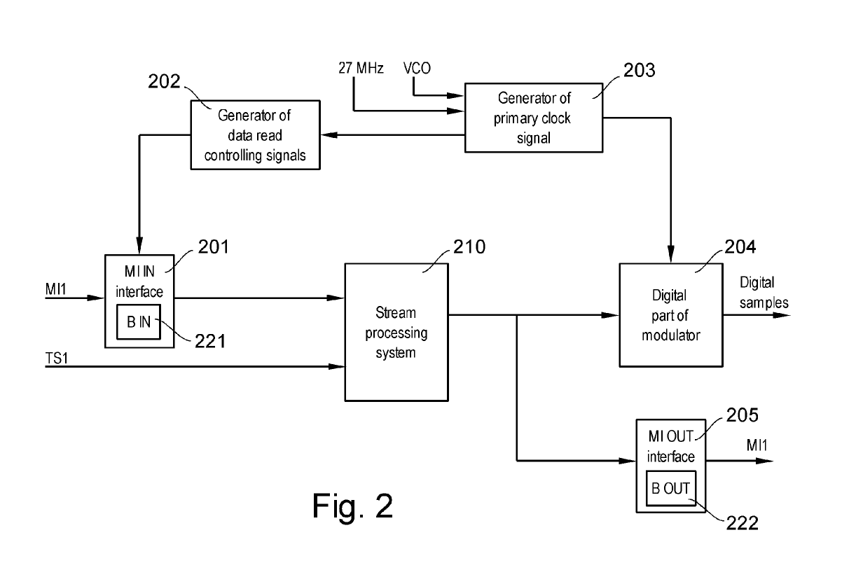

The signal controller shown in FIG. 1 consists of two main elements, namely a signal processing system and the digital part of the modulator. It is presented in details in FIG. 2. The signal processing system consists of an input interface MI IN 201, the output interface MI OUT 205, the generator of data read controlling signals 202, the generator of primary clock signal 203 and the stream processing system 210, which processes the received streams (in the simplest embodiment it receives TS1 and MI1 streams). Stream processing may include packet filtering, change of packet content, stream mixing or adding stuffing packets. The primary clock signal generator 203 provides a signal with adequate frequency for controlling the speed of symbol processing in the modulator, where the signal is based on the frequency of the VCO (Voltage Controlled Oscillator) and the master frequency (for example 27 MHz).

The MI1 stream comprising data passes through the input interface MI IN 201, which changes the stream format from the MI to TS format. The speed of data fetching from the processor is controlled by the generator of data read controlling signals 202, which is connected to the input interface MI IN 201. The MI IN 201 interface can additionally contain a B IN buffer 221, capable of storing a number of packets of input data. Similarly, the output data pass through the output interface MI OUT 205, which changes the stream format into the format of processor bus (MI). The MI OUT 205 interface can additionally contain a B OUT buffer 222, capable of storing a number of packets of output data. Packet buffering is especially useful, when the processor sends data irregularly, which does not allow continuous generation of a stream in TS format. The stream generated by the stream processing system 210 is transmitted to the digital part of the modulator 204 and, through the output interface MI OUT 205 to the processor. The digital part of the modulator 204 generates the digital samples for the analog part of the modulator, located outside of the signal controller.

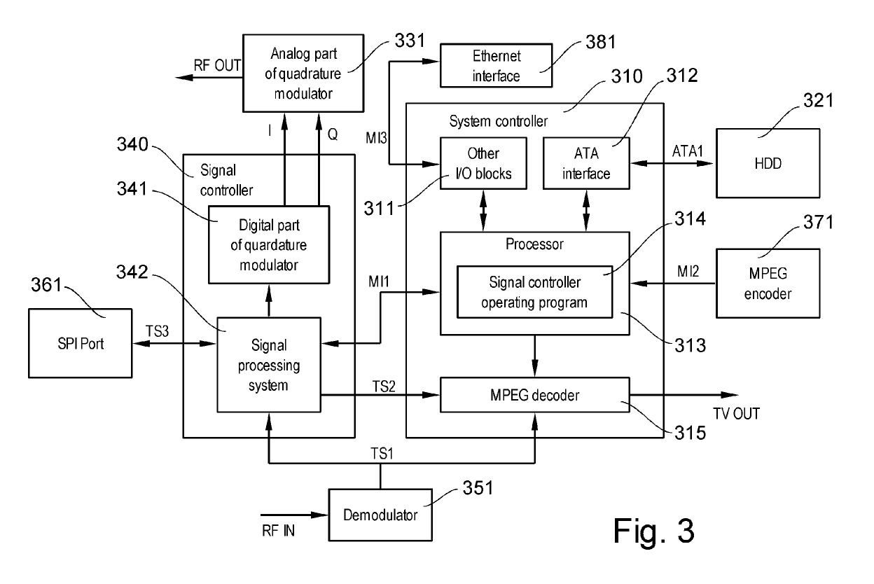

FIG. 3 presents the structure of the extended embodiment of a data processing system. As compared to the system shown in FIG. 1, besides a hard disk drive 321 and a demodulator 351, it additionally comprises an Ethernet interface 381, an MPEG encoder 371, and a bidirectional SPI (Synchronous Parallel Interface) port 361, to which an external device can be connected, for example, and additional modulator. The processor 313 of this system operates different programs, including a program 314 for operating the signal controller 340. The extended embodiment utilizes a quadrature modulator. Therefore, I and Q samples are transmitted between the digital part 341 and the analog part 331 of the modulator.

The MPEG encoder 371 is a source of an additional stream and is controlled by the processor. The MPEG encoder 371 can receive analog signal from an external device (for example, a video camera) and transform it into a digital data stream MI2. The Ethernet interface 381 connected to the other input/output blocks 311 of the system controller 310 with an interface ATA 312, enables communication through the Ethernet network.

As compared to the basic embodiment, additional data streams are transmitted in the extended embodiment of the system, namely MI2, MI3, TS2 and TS3 streams. MI2 is a data stream transmitted unidirectionally between the MPEG encoder 371 and the processor 313. The exchange of data between the MPEG encoder 371 and the processor 313 can be also utilized using another interface, for example a TS interface. MI3 is a data stream transmitted bidirectionally between a specific input/output block 311 in the system controller 310, and the Ethernet interface 381—this stream can also be sent by interface of a different type, for example a PCI (Peripheral Component Interconnect) interface. TS2 provides an additional path for sending data from the signal processing system 342 to the system controller 310, and more precisely, in TS format unidirectionally to the MPEG decoder 315. TS3 is a data stream transmitted bidirectionally between the SPI port 361 and the signal processing system 342.

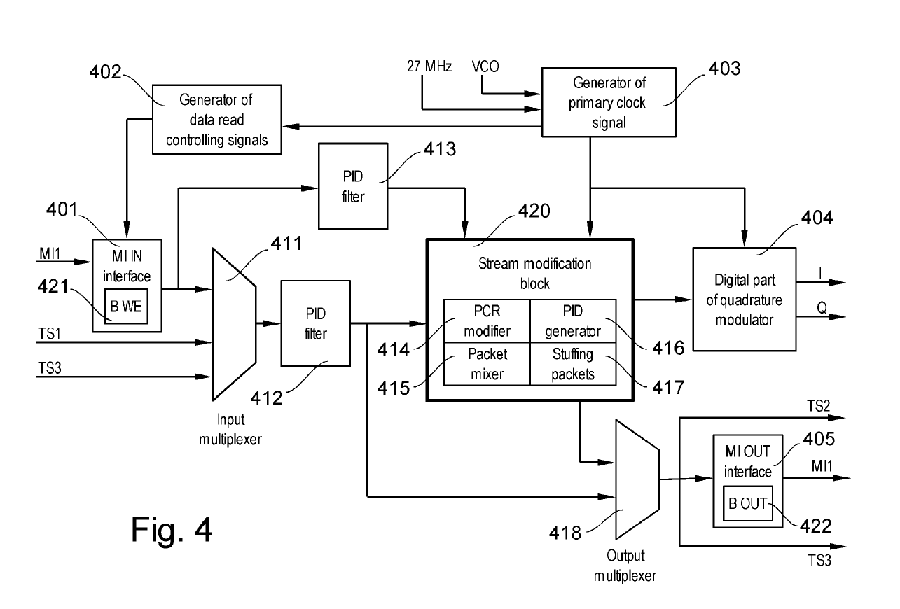

FIG. 4 presents the structure of the exemplary extended embodiment of the signal controller 340 used in the extended version of the system, illustrated in FIG. 3. The signal processing system, like the system shown in FIG. 2, consists of an input interface MI IN 401, the output interface MI OUT 405, the generator of data read controlling signals 402 and the generator of primary clock signal 403. The stream processing system 210 shown in FIG. 2 is replaced by a system that consists of an input multiplexer 411, PID filters 412, 413, a stream modification block 420 and an output multiplexer 418. The input multiplexer 411 receives the input streams TS1, TS3 and the stream from MI IN interface 401, converted from MI format to TS format. The input multiplexer 411 sends a selected stream to its output. This stream next passes through the first PID filter 412, which allows removing specific packets from the stream, the packets being identified by a PID (Packet Identifier) number. The stream from the MI IN interface 401, passes also through the second PID filter 413. Filtering packets allows decreasing the amount of data transmitted in the stream, and therefore decreasing the speed of transfer of data of the modulated stream. The PIDs of packets to be deleted can be entered individually or as a range of numbers. Data from PID filters 412, 413 are input to the stream modification block 420, which allows further operations on streams, provided for example by the PCR modifier 414, the packet mixer 415, the PID generator 416 and the block of inserting of stuffing packets 417. The PCR modifier 414 allows modifying the PCR (Program Clock Reference) data in packets. The packet mixer 415 allows mixing two streams. The PID generator 416 allows changing the PID numbers of packets. The block of inserting the stuffing packets 417 allows filling the output stream with stuffing packets. The output stream from the stream modification block 420 is sent to the digital part of the quadrature modulator 404 and to the output multiplexer 418. The output multiplexer 418 sends the modified stream or the stream generated by the PID filter 412 to its output. The output data are transmitted as TS2 and TS3 streams, as well as the MI1 stream generated by the MI OUT interface 405. The MI OUT interface 405 can include a B OUT 422 buffer, which is capable of storing a number of output data packets, and the input interface MI IN 401 can include a B IN 421 buffer, which is capable of storing a number of input data packets.

The presented solution can be used for generating a test stream for digital television decoders. The test stream is generated on the basis of at least two streams in the MPEG format. The first one is for example a cable, terrestrial or satellite RF IN television stream, which is received and demodulated by the demodulator 151, 351 and the second stream is read from the hard disk drive 121, 321. These streams are next transmitted to the signal controller 140, 340, in which they are processed. The output streams from the signal controller 140, 340, after modulation in the analog part of the modulator 131, 331 can be used as RF OUT test stream.

The presented system is based on components commonly used in digital television decoders. The use of common components makes the cost of the presented system much lower in comparison to other test systems, such as the systems based on a PC-type computer.

It will be understood that each of the elements described above, or two or more together, may also find a useful application in other types of systems for processing data streams from the types described above.

While the invention has been illustrated and described as embodied in the context of a system for processing data streams in MPEG, it is not intended to be limited to the details shown, since various modifications may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A system for processing data streams in MPEG format comprising
a system controller having a processor with an ATA interface, an MPEG decoder and other I/O blocks;
a memory for storing data streams linked to the system controller;
a demodulator linked to the system controller;
a signal controller linked to the system controller and containing a signal processing system and a digital part of modulator; and
an analog part of modulator connected with the digital part of modulator of the signal controller and the processor of the system controller
wherein the signal processing system of the signal controller receives a first digital data stream from the demodulator and a second digital data stream from the processor and after processing them, it sends an output stream to the digital part of modulator and to the processor.

2. The system for processing streams according to claim 1, wherein the software of the processor of the system controller contains a signal controller operating program for controlling operation of the signal controller.

3. The system for processing streams according to claim 1, wherein the memory for storing data streams is a hard disk drive.

4. The system for processing streams according to claim 1 further comprising an additional data interface connected to the signal processing system.

5. The system for processing streams according to claim 4 wherein the additional data interface connected to the signal processing system is an SPI port (361).

6. The system for processing streams according to claim 1 further comprising an additional data interface connected to the system controller.

7. The system for processing streams according to claim 6 wherein the additional data interface connected to the system controller is an Ethernet interface.

8. The system for processing streams according to claim 1 further comprising an additional data source connected to the processor.

9. The system for processing streams according to claim 1 wherein the additional data source connected to the processor is an MPEG encoder.

10. The system for processing streams according to claim 1 wherein the signal processing system receives data from the processor in a Memory Interface format and processes data internally in a Transport Stream format, and wherein the signal processing system contains an input interface and an output interface for exchanging data with the processor which convert data from the Transport Stream format to the Memory Interface format and vice versa.

11. The system for processing streams according to claim 10 wherein the input interface and the output interface for exchanging data with the processor contain buffers for preventing irregular data transfer.

12. The system for processing streams according to claim 1 wherein the signal processing system contains PID filters, a PCR modifier, a packet mixer, a PID generator and/or a block for inserting stuffing packets.

13. A method for processing data streams in MPEG format in a system for processing data streams, containing a system controller with a processor and an MPEG decoder, a memory for storing data streams, a demodulator, a signal controller linked to the system controller and containing a signal processing system and a digital part of modulator and an analog part of modulator, the method comprising following steps:
receiving at least two streams by the signal controller; and
processing the received streams by the signal processing system, outputting a single output stream and modulating it by the analog and digital parts of modulator to a specific modulation system.

14. The method for processing data streams according to claim 13 wherein the streams are received from the demodulator and/or the hard disk drive and/or an external source.

15. The method for processing data streams according to claim 13 wherein the processing of the received streams involves packet filtering and streams mixing.

16. The method for processing data streams according to claim 13 wherein the output unmodulated stream is sent to the MPEG decoder.

17. The method for processing data streams according to claim 13 wherein the output stream after modulation is used as a test stream for digital television decoders.

18. A method for processing data streams in MPEG format in a system for processing data streams, containing a system controller with a processor and an MPEG decoder, a memory for storing data streams, a demodulator, a signal controller linked to the system controller and containing a signal processing system and a digital part of modulator and an analog part of modulator, the method comprising following steps:
receiving by the signal controller a data stream from the demodulator and from the processor;
processing the received data streams by the signal processing system into an output stream;
sending the output stream to the digital part of modulator and to the processor.

19. The method for processing data streams according to claim 18, wherein the stream received from the demodulator is in the Transport Stream format, the stream received from the processor is in the Memory Interface format, the stream sent to the digital part of modulator is in the Transport Stream format and the stream sent to the processor in the Memory Interface format.
